(19) United States
(12) Patent Application Publication
(10) Pub. No.: US 2026/0129499 A1
(43) Pub. Date: May 7, 2026

(54) COMMUNICATION METHOD AND DEVICE

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(21) Appl. No.: 19/441,165

(22) Filed: Jan. 6, 2026

Related U.S. Application Data
(63) Continuation of application No. PCT/CN2023/110023, filed on Jul. 28, 2023.

(51) Int. Cl. H04W 24/10; H04W 72/563

(52) U.S. Cl. CPC H04W 24/10; H04W 72/563

(57) ABSTRACT

A communication method comprises: determining, by a first communication device, whether to transmit a first measurement report based on a first condition in response to a first-type frequency point meeting a first reporting condition.

### CROSS-REFERENCE TO RELATED APPLICATION

This application is a Continuation Application of International Application No. PCT/CN2023/110023 filed on July 28, 2023, which is incorporated herein by reference in its entirety.

### TECHNICAL FIELD

The present disclosure relates to the field of communications, and more particular, to a communication method and a device.

### RELATED ART

In some scenarios, a wireless mobile communication system needs to perform measurement on cell quality and/or beam quality. A network may configure a terminal with information such as a frequency point list on which the measurement need to be performed and their corresponding reporting criteria. After performing measurement on a frequency point, the terminal directly reports a measurement result of the frequency point to the network.

### SUMMARY

Embodiments of the present disclosure provide a communication method, a first communication device and a second communication device.

The embodiments of the present disclosure provide a communication method, which includes: determining, by a first communication device, whether to transmit a first measurement report based on a first condition in response to a first-type frequency point meeting a first reporting condition.

The embodiments of the present disclosure provide a first communication device, which includes: a processor, and a memory. The memory is configured to store a computer program, and the processor is configured to call the computer program stored in the memory and run the computer program, to enable the first communication device to perform: determining whether to transmit a first measurement report based on a first condition in response to a first-type frequency point meeting a first reporting condition.

The embodiments of the present disclosure provide a second communication device, which includes: a processor, and a memory. The memory is configured to store a computer program, and the processor is configured to call the computer program stored in the memory and run the computer program, to enable the second communication device to perform: transmitting a first measurement configuration, where the first measurement configuration is used for assisting a first communication device in determining whether to transmit a first measurement report based on a first condition in response to a first-type frequency point meeting a first reporting condition.

### BRIEF DESCRIPTION OF THE DRAWINGS

FIG. 1 is a schematic diagram of an application scenario according to embodiments of the present disclosure.

FIG. 2 is a schematic diagram of a radio resource management (RRM) measurement model in a new radio (NR) system according to the present disclosure.

FIG. 3 is a schematic diagram of an RRM measurement configuration according to the present disclosure.

FIG. 4 is a schematic flowchart of a communication method according to an embodiment of the present disclosure.

FIG. 5 is a schematic flowchart of a communication method according to another embodiment of the present disclosure.

FIG. 6 is a schematic flowchart of a communication method according to an embodiment of the present disclosure.

FIG. 7 is a schematic flowchart of a communication method according to another embodiment of the present disclosure.

FIG. 8 is a schematic block diagram of a first communication device according to an embodiment of the present disclosure.

FIG. 9 is a schematic block diagram of a first communication device according to another embodiment of the present disclosure.

FIG. 10 is a schematic block diagram of a second communication device according to an embodiment of the present disclosure.

FIG. 11 is a schematic block diagram of a second communication device according to another embodiment of the present disclosure.

FIG. 12 is a schematic block diagram of a communication device according to the embodiments of the present disclosure.

FIG. 13 is a schematic block diagram of a chip according to the embodiments of the present disclosure.

FIG. 14 is a schematic block diagram of a communication system according to the embodiments of the present disclosure.

### DETAILED DESCRIPTION

Technical solutions in the embodiments of the present disclosure are described below with reference to the accompanying drawings in the embodiments of the present disclosure.

The technical solutions in the embodiments of the present disclosure may be applied to various communication systems, such as a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial communication network (non-terrestrial networks, NTN) system, a universal mobile telecommunications system (UMTS), a wireless local area network (WLAN), wireless fidelity (WiFi), a 5th-generation (5G) communication system and other communication systems.

Generally speaking, traditional communication systems support a limited number of connections, which is easy to be implemented. However, with the development of the communication technology, mobile communication systems will not only support traditional communications, but also support, for example, device to device (D2D) communication, machine to machine (M2M) communication, machine type communication (MTC), vehicle to vehicle (V2V) communication, or vehicle to everything (V2X) communication. The embodiments of the present disclosure may be applied to these communication systems as well.

In an implementation, the communication system in the embodiments of the present disclosure may be applied to a carrier aggregation (CA) scenario, and a dual connectivity (DC) scenario, and may also be applied to a standalone (SA) network deployment scenario.

In an implementation, the communication system in the embodiments of the present disclosure may be applied to an unlicensed spectrum, where the unlicensed spectrum may also be considered as a shared spectrum. Alternatively, the communication system in the embodiments of the present disclosure may be applied to a licensed spectrum, where the licensed spectrum may be considered as an unshared spectrum.

In the embodiments of the present disclosure, various embodiments are described in conjunction with a network device and a terminal device; the terminal device may be referred to as a user equipment (UE), an access terminal, a user unit, a user station, a mobile station, a mobile platform, a remote station, a remote terminal, a mobile device, a user terminal, a terminal, a wireless communication device, a user agent, a user apparatus, or the like.

The terminal device may be a station (ST) in the WLAN, or may be a cellular phone, a cordless phone, a session initiation protocol (SIP) phone, a wireless local loop (WLL) station, a personal digital assistant (PDA) device, a handheld device with a wireless communication function, a computing device or other processing devices connected to a wireless modem, an in-vehicle device, a wearable device, a terminal device in a next generation communication system (e.g., an NR network), a terminal device in a future evolved public land mobile network (PLMN) network, or the like.

In the embodiments of the present disclosure, the terminal device may be deployed on land, including indoor or outdoor, handheld, wearable, or in-vehicle; the terminal device may also be deployed on water (e.g., on a steamship); the terminal device may also be deployed in air (e.g., on an airplane, on a balloon, or on a satellite).

In the embodiments of the present disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, or the like.

As an example and not a limitation, in the embodiments of the present disclosure, the terminal device may be a wearable device. The wearable device may be referred to as a wearable smart device, which is a general term for wearable devices developed by performing the intellectualized design on daily wear by applying wearable technologies, such as glasses, gloves, watches, clothing and shoes. The wearable device is a portable device that is worn directly on a body, or integrated into clothes or accessories of users. The wearable device not only is a hardware device, but also implements powerful functions by software support as well as data interaction or cloud interaction. Generalized wearable smart devices include devices that are fully functional, large in size, and capable of implementing full or partial functions without relying on smart phones, such as smart watches or smart glasses; as well as devices that only focus on a certain type of application function and need to be used in conjunction with other devices (e.g., a smart phone), such as various smart bracelets and smart jewelry that monitor physical signs.

In the embodiments of the present disclosure, the network device may be a device used for communicating with a mobile device. The network device may be an access point (AP) in WLAN, or may be an evolutional base station (Evolutional Node B, eNB or eNodeB) in LTE, a relay station or an access point, or an in-vehicle device, a wearable device, a network device (next Generation Node B, gNB) in an NR network, a network device in a future evolved PLMN network, a network device in an NTN network, or the like.

As an example but not a limitation, in the embodiments of the present disclosure, the network device may have mobile characteristics. For example, the network device may be a device which is mobile. Optionally, the network device may be a satellite, or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may be a base station deployed on land, water, or other places.

In the embodiments of the present disclosure, the network device may provide service(s) for a cell, and the terminal device communicates with the network device through a transmission resource (e.g., a frequency-domain resource, or a spectrum resource) used by the cell. The cell may be a cell corresponding to the network device (e.g., a base station), and the cell may belong to a macro base station, or may belong to a base station corresponding to a small cell. The small cell here may include: a metro cell, a micro cell, a pico cell, or a femto cell, or the like. These small cells have characteristics of small coverage ranges and low transmission power, which are applicable for providing a data transmission service with high speed.

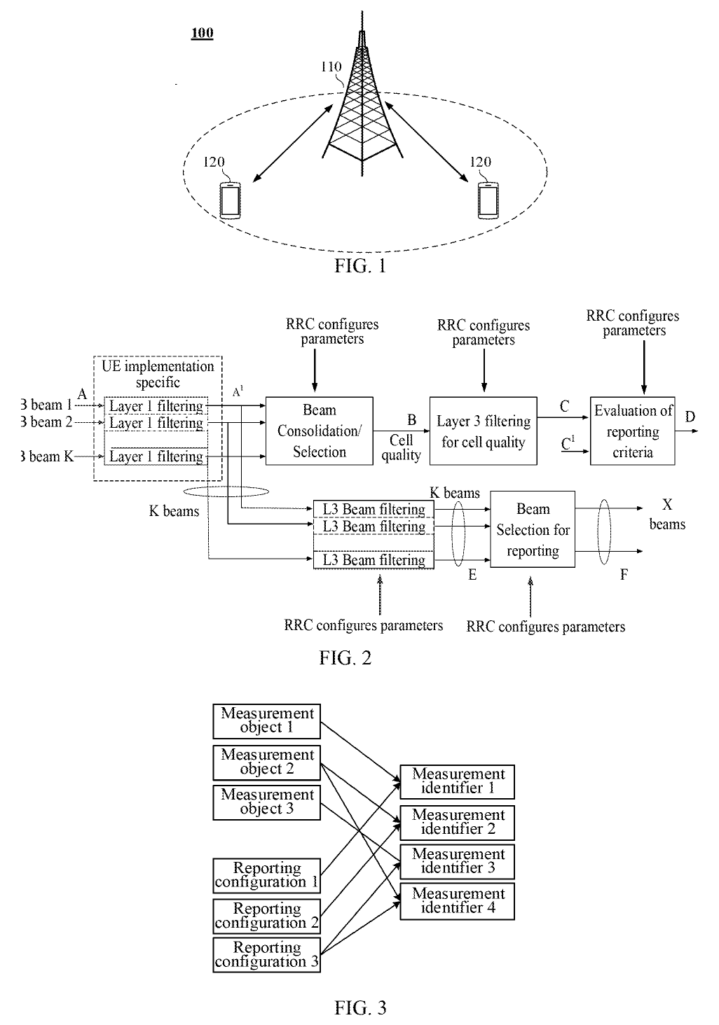

FIG. 1 exemplarily illustrates a communication system 100. The communication system includes a network device 110 and two terminal devices 120. In an implementation, the communication system 100 may include multiple network devices 110, and there are other number of terminal devices 120 in the coverage range of each network device 110, which is not limited in the embodiments of the present disclosure.

In an implementation, the communication system 100 may further include other network entities such as a mobility management entity (MME) and an access and mobility management function (AMF), which are not limited in the embodiments of the present disclosure.

The network device may include an access network device and a core network device. That is, the wireless communication system further includes multiple core networks for communicating with the access network device. The access network device may be an evolutional base station (evolutional node B, which may be abbreviated as eNB or e-NodeB), a macro base station, a micro base station (also called small base station), a pico base station, an access point (AP), a transmission point (TP) or a new generation base station (new generation Node B, gNodeB), or the like in a long-term evolution (LTE) system, a next-generation mobile communication (next radio, NR) system, or in an authorized auxiliary access long-term evolution (LAA-LTE) system.

It should be understood that, in the embodiments of the present disclosure, a device with a communication function in the network/system may be referred to as a communication device. Considering the communication system illustrated in FIG. 1 as an example, the communication device may include a network device and terminal device that with a communication function. The network device and the terminal device may be the specific devices in the embodiments of the present disclosure, which will not be repeated here. The communication device may further include other devices in the communication system, such as a network controller, a mobility management entity, and other network entities, which are not limited in the embodiments of the present disclosure.

It should be understood that the terms "system" and "network" are often used interchangeably herein. The term "and/or" herein is only an association relationship to describe associated objects, indicating that there may be three kinds of relationships; for example, "A and/or B" may represent three cases where: A exists alone, both A and B exist, and B exist alone. In addition, a character "/" herein generally indicates that the associated objects before and after this character are in an "or" relationship.

It should be understood that, "indicate" mentioned in the embodiments of the present disclosure may mean a direct indication, an indirect indication, or may mean that there is an association relationship. For example, A indicating B may mean that A directly indicates B, and for example, B may be acquired by A; alternatively, A indicating B may mean that A indirectly indicates B, and for example, A indicates C, and B may be acquired by C; alternatively, A indicating B may mean that there is an association relationship between A and B.

In the description of the embodiments of the present disclosure, the term "correspond" may mean that there is a direct correspondence or an indirect correspondence between the two, or may mean that there is an association relationship between the two, or may mean a relationship of indicating and being indicated, or a relationship of configuring and being configured, or the like.

To facilitate understanding of the technical solutions of the embodiments of the present disclosure, the relevant technologies of the embodiments of the present disclosure are described below. The following relevant technologies, as optional solutions, may be arbitrarily combined with the technical solutions of the embodiments of the present disclosure, and those combined solutions all belong to the protection scope of the embodiments of the present disclosure.

### Radio resource management (RRM) measurement

For wireless mobile communication systems, accurate measurement of cell quality and beam quality is the basis of effectively performing the radio resource management and mobility management. FIG. 2 illustrates an example of an RRM measurement model in an NR system.

Beamforming is introduced in the NR system. In the implementation of the RRM measurement, the UE needs to measure various beams respectively and then derive a cell measurement result based on beam measurement results. Exemplarily, a UE physical layer performs the RRM measurement to obtain measurement results of multiple beams and submits them to a radio resource control (RRC) layer. At the RRC layer, the UE takes a linear average value of N largest beam measurement results that meet a certain threshold to obtain the cell measurement result. Here, the threshold and the maximum number of beams are configured through RRC dedicated signaling. In a case where the network does not configure the threshold and the maximum number of beams, the UE selects an optimal beam measurement result as the cell measurement result. In order to reduce random interference during the measurement process, generated cell measurement result is filtered by layer 3 (L3) before triggering a measurement report.

For a UE in a connected state, basic measurement configuration of the NR system (e.g., configured through a measurement configuration information element (measConfig IE)) may include following parts.

1. Measurement object: the measurement object identifies frequency point information on which the UE performs measurement. The NR system supports measurements of two reference signals: a synchronization signal/physical broadcast channel (PBCH) block (SSB) and a channel status indicator reference signal (CSI-RS). For SSB measurement, the frequency point information is an SSB frequency point associated with the measurement object. Since the 5G system supports transmissions with multiple different subcarrier spacings, the measurement object needs to indicate an SSB subcarrier spacing related to the measurement. For measurement configuration of the SSB reference signal, the measurement object further needs to additionally indicate time window information of the SSB measurement, i.e., SSB measurement timing configuration (SMTC) information. The network may further indicate information such as the UE measuring which SSBs within the SMTC. For measurement configuration of the CSI-RS reference signal, the measurement object includes configuration of a CSI-RS resource. In order to enable the UE to derive the cell measurement result from the beam measurement results, the measurement object is further configured with threshold values for filtering beam measurement result(s) based on the SSB and the CSI-RS, as well as the maximum number of beams allowed for linear average calculation. For L3 filtering of the beam measurement results and the cell measurement results, the measurement object further indicates specific filtering coefficients based on different measurement reference signals.

2. Reporting configuration: the reporting configuration mainly includes configuration information such as reporting criteria, reference signal types and reporting manners. Like LTE systems, the NR supports periodic reporting, event-triggered reporting, common gateway interface (CGI) reporting for auto neighbor relationship (ANR) purposes, and system frame number and frame timing difference (SFTD) reporting for measuring time differences. For the periodic reporting and the event-triggered reporting, the reporting configuration specifies a reference signal type (e.g., the SSB or the CSI-RS), the measurement reporting quantity (e.g., any combination of reference signal received power (RSRP), reference signal received quality (RSRQ), and signal interference noise ratio (SINR)), whether to report beam measurement results, and the maximum number of beams capable of being reported. For the event-triggered reporting, the reporting configuration specifies a measurement triggering quantity for each event, which is one of the RSRP, the RSRQ, and the SINR.

3. Association relationships between measurement objects and reporting configurations, which are illustrated in FIG. 3. This association manner is relatively flexible and may implement any combination of the measurement objects and the reporting configurations. That is, one measurement object may be associated with multiple reporting configurations, and one reporting configuration may also be associated with multiple measurement objects. A measurement identifier will be carried in the measurement report for reference by the network side.

4. Measurement filter configuration, including measurement filter coefficients.

5. Measurement interval, used for performing inter-frequency or inter-system measurements. During the measurement interval, the UE stops measuring of all services and serving cells.

The network configures the UE with a frequency point list on which the measurement need to be performed and their corresponding reporting criteria through the measConfig IE. For multiple frequency points to be measured in the list, the UE determines an order in which measurements are performed based on the implementation. In a case where a measured frequency point meets a reporting trigger event, the UE will directly report a measurement result of the frequency point without waiting for measurement results of other frequencies.

The network selects a target cell that the UE is capable of accessing based on the measurement result reported by the UE. However, in some scenarios, a frequency point that the UE choose to perform measurement first may not be an optimal frequency point considered by the network. For example, the network configures the UE to perform measurements on Frequency point 1 and Frequency point 2. Here, Frequency point 1 has better coverage and is optimized for voice calls (e.g., a voice over long term evolution (VoLTE) fallback scenario). However, the UE choose to perform measurement first on Frequency point 2 based on the implementation, and reports a measurement result of the Frequency point 2 to the network in a case where the reporting condition is met. In this case, the network may only hand over the UE to a cell at Frequency point 2 based on the measurement result reporting.

For the above problem, in the embodiments of the present disclosure, a measurement reporting mechanism may be enhanced to assist the network in timely obtaining a measurement result of a frequency point of interesting and/or a measurement state of the frequency point on the UE side.

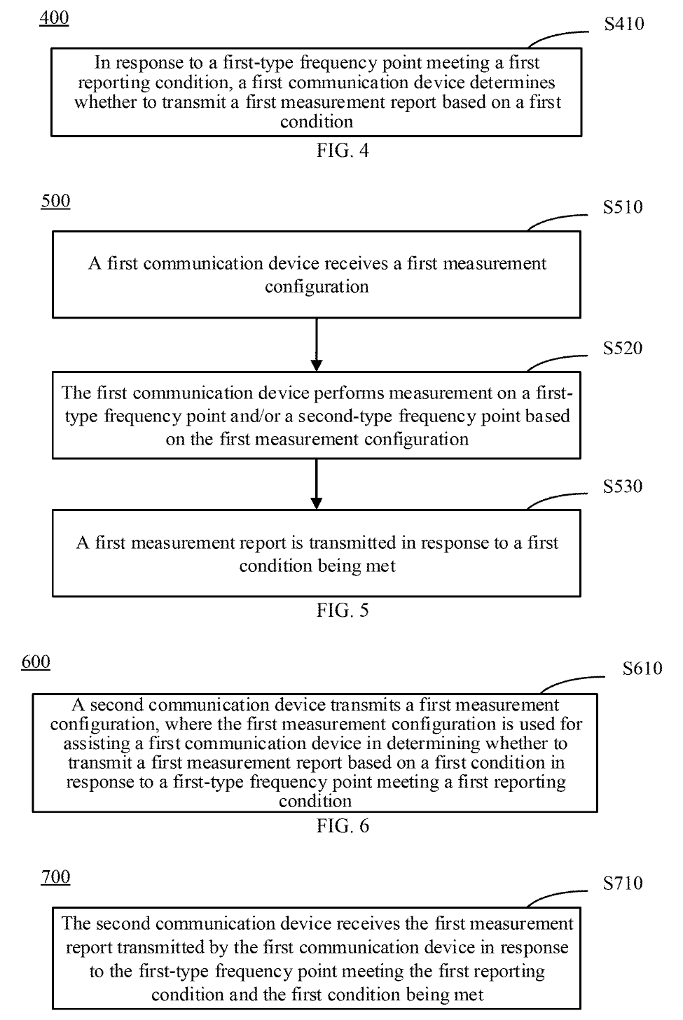

FIG. 4 is a schematic flowchart of a communication method 400 according to an embodiment of the present disclosure. The method may optionally be applied to the system illustrated in FIG. 1, but is not limited thereto. The method includes at least part of following contents.

In S410, in response to that a first-type frequency point meets a first reporting condition, a first communication device determines whether to transmit a first measurement report based on a first condition.

In the embodiments of the present disclosure, the first communication device may perform measurement on multiple frequency points to be measured in a certain order. The first-type frequency point may include a frequency point that the first communication device chooses to perform measurement first. The first-type frequency point may also be referred to a first-kind frequency point, a first-group frequency point, a first frequency point, or the like. The first-type frequency point may include one or more frequency points measured by the first communication device. The frequency point measured by the communication device may be referred to as a measurement frequency point for short. After measuring the first-type frequency point, the first communication device may determine whether the first-type frequency point meets the first reporting condition based on a measurement result; in response to the first-type frequency point meeting the first reporting condition, the first communication device may not perform reporting immediately, but determine whether to transmit the first measurement report to a second communication device based on the first condition.

In the embodiments of the present disclosure, the first reporting condition may include multiple types of conditions. For example, the measurement result of the first-type frequency point meets a certain threshold or a measurement report triggering event. The measurement report triggering event may include A1-A6 events, a B1 event, a B2 event, and a D1 event. Here, several examples of the A4 event or A5 event are as follows: RSRP of the first-type frequency point being greater than a corresponding threshold; RSRQ of the first-type frequency point being greater than a corresponding threshold; SINR of the first frequency point being greater than a corresponding threshold; the RSRP, RSRQ or SINR of the first-type frequency point being greater than the corresponding threshold and lasting for a time to trigger (TTT) duration; the RSRP, RSRQ or SINR of the first frequency point being higher than RSRP, RSRQ or SINR of a previous serving cell by a threshold and lasting for the TTT duration.

In the embodiments of the present disclosure, in a case where the first-type frequency point meets the first reporting condition, a more appropriate measurement result may be reported more flexibly based on the first condition. For example, in a case where the frequency point that the first communication device chooses to perform measurement first is not an optimal frequency point considered by the network, the first communication device may wait for measurement results of other frequency points before determining the content included in the first measurement report to be reported. Thus, a measurement result of a better frequency point may be reported, which may assist the second communication device, such as a network device, in timely obtaining a measurement result of a frequency point of more interesting and/or a measurement state of a frequency point by the first communication device.

In a scenario, the first communication device may include a terminal device, and the second communication device receiving the first measurement report may include a network device.

In another scenario, the first communication device may include a first terminal device, and the second communication device receiving the first measurement report may include a second terminal device.

FIG. 5 is a schematic flowchart of a communication method 500 according to another embodiment of the present disclosure. The method may include one or more features of the above communication method. In an implementation, the method further includes the following.

In S510, the first communication device receives a first measurement configuration.

In S520, the first communication device performs measurement on the first-type frequency point and/or a second-type frequency point based on the first measurement configuration.

In the embodiments of the present disclosure, the first communication device may receive the first measurement configuration from the second communication device. For example, the terminal device receives the first measurement configuration from the network device, or the first terminal device receives the first measurement configuration from the second terminal device. The first measurement configuration may be pre-configured or dynamically configured. The first measurement configuration may indicate that which frequency points need to be measured. For example, in a case where the first measurement configuration indicates that the frequency point(s) that need to be measured includes the first-type frequency point, the first communication device may perform measurement on the first-type frequency point. In a case where the first measurement configuration indicates that the frequency point(s) that need to be measured includes the second-type frequency point, the first communication device may perform measurement on the second-type frequency point. In a case where the first measurement configuration indicates that the frequency point(s) that need to be measured includes the first-type frequency point and the second-type frequency point, the first communication device may perform measurement on the first-type frequency point and the second-type frequency point. For example, the first communication device may perform measurement on the first-type frequency point first and then perform measurement on the second-type frequency point, or perform measurement on the first-type frequency point and the second-type frequency point at the same time, or determine an order of performing measurement on the first-type frequency point and the second-type frequency point based on a priority configuration of the frequency points.

In an implementation, the first measurement configuration includes at least one of following: a threshold related to a measurement result; a first timer duration; a priority threshold; a first frequency point list; first indication information; or a cell list.

In the embodiments of the present disclosure, the first measurement configuration includes a threshold related to the measurement result, such as a threshold corresponding to a measurement result of the first-type frequency point, a first threshold corresponding to a measurement result of the second-type frequency point, a second threshold corresponding to a measurement result of a serving cell, or a third threshold corresponding to a difference between measurement results of different-types of frequency points.

In the embodiments of the present disclosure, the first frequency point list may include one or more frequency points at which the first communication device directly transmits the first measurement report in response to that the reporting condition is met. For example, the first frequency point list includes first-type frequency points, i.e., F1, F2, and F3. In response to measuring that the F1 meets the first reporting condition, the first communication device directly transmits a first measurement report including a measurement result of the F1 to the second communication device.

In an implementation, as illustrated in FIG. 5, in S410, determining whether to transmit the first measurement report based on the first condition includes S530 in which transmitting the first measurement report in response to the first condition being met. For example, in response to the first-type frequency point meeting the first reporting condition and the first condition is met, the first communication device transmits the first measurement report to the second communication device.

In an implementation, multiple first-type frequency points may be associated with a same first condition or associated with different first conditions. For example, the network configures three first-type frequency bands, i.e., F1, F2, and F3. The first condition configured by the network for the F1 is based on a first timer, the first condition configured by the network for the F2 is based on a first threshold, and the first condition configured by the network for the F3 is based on an indication.

In an implementation, the first condition includes at least one of following:

a measurement result of a second-type frequency point meeting a first threshold;

a first timer timing out;

a measurement result of a current serving cell meeting a second threshold;

a difference between a measurement result of the first-type frequency point and a measurement result of the second-type frequency point meeting a third threshold;

determining, based on a network indication, that the first-type frequency point is a frequency point at which a measurement result is allowed to be directly reported in response to a reporting condition being met;

a priority of the first-type frequency point being not lower than a priority threshold;

a first cell at the first-type frequency point meeting a reporting condition;

at least N cells at the first-type frequency point that meet a reporting condition existing, N being a positive integer; or

it being predicted that measurement reporting at a second-type frequency point will be triggered within a first-time window.

In the embodiments of the present disclosure, the above various first conditions may be used individually or in combination. For example, in response to the measurement result of the second-type frequency point meeting the first threshold and the first timer times out, it is determined that the first condition is met. As another example, in response to the measurement result of the second-type frequency point meeting the first threshold and the difference between the measurement result of the first-type frequency point and the measurement result of the second-type frequency point meeting the third threshold, it is determined that the first condition is met. As still another example, in response to a priority of the first-type frequency point being not lower than a priority threshold and the first cell at the first-type frequency point meeting the reporting condition, it is determined that the first condition is met. As still another example, in response to at least N cells at the first-type of frequency that meet the reporting condition existing and the measurement result of the current serving cell meeting the second threshold, it is determined that the first condition is met. As still another example, in response to it being predicted that the measurement report of the second-type frequency point will be triggered within the first-time window based on an AI model, it may be determined that the first condition is met, and the first measurement report may be reported after the measurement of the second-type frequency point is completed.

In an implementation, in response to the first-type frequency point meeting the first reporting condition, determining whether to transmit the first measurement report based on the first condition includes one or more of following Manner 1, Manner 2 or Manner 3.

Manner 1: in response to the measurement result of the first-type frequency point meeting the first reporting condition, the first communication device determines whether to transmit the first measurement report based on the measurement result of the second-type frequency point.

In the embodiments of the present disclosure, in a case where one or more of the first threshold, the second threshold, and the third threshold are indicated in the first measurement configuration, the first communication device may determine whether to transmit the first measurement report based on the measurement result of the second-type frequency point.

In an implementation, in response to the measurement result of the first-type frequency point meeting the first reporting condition, the first communication device determining whether to transmit the first measurement report based on the measurement result of the second-type frequency point includes at least one of following:

transmitting, by the first communication device, the first measurement report in response to the measurement result of the second-type frequency point meeting the first threshold;

transmitting, by the first communication device, the first measurement report in response to the difference between the measurement result of the second-type frequency point and the measurement result of the first-type frequency point meeting the third threshold; or

transmitting, by the first communication device, the first measurement report in response to the measurement result of the current serving cell meeting the second threshold.

In the embodiments of the present disclosure, there are multiple situations in which the measurement result of the second-type frequency point meets the first threshold. For example, in a case where an RSRP of the second-type frequency point is greater than, less than, or equal to an RSRP threshold, a first measurement report including the measurement result of the first-type frequency point and the measurement result of the second-type frequency point may be transmitted.

In the embodiments of the present disclosure, there are multiple situations in which a difference between measurement results of different types of frequency points meets the third threshold. As another example, in response to that a difference between an RSRP of the second-type frequency point and an RSRP of the first-type frequency point is greater than, less than, or equal to an RSRP difference threshold, the first communication device transmits the first measurement report.

In the embodiments of the present disclosure, the second-type frequency point may include the current serving cell, or the second-type frequency point may not include the current serving cell. In this case, in response to the measurement result of the first-type frequency point meeting the first reporting condition, the first communication device may determine whether to transmit the first measurement report based on the measurement result of the current serving cell.

Manner 2: in response to the measurement result of the first-type frequency point meeting the first reporting condition, the first communication device starts a first timer, and then determines whether to transmit the first measurement report based on a state of the first timer.

In the embodiments of the present disclosure, in a case where the first measurement configuration indicates the first timer duration, the first communication device may determine whether to transmit the first measurement report based on the state of the first timer.

In an implementation, determining whether to transmit the first measurement report based on the state of the first timer includes at least one of following:

the first communication device transmitting the first measurement report in response to the first timer timing out;

the first communication device transmitting the first measurement report in response to the first timer timing out and the measurement result of the first-type frequency point meeting the first reporting condition;

during running of the first timer, the first communication device stopping the first timer and transmitting the first measurement report in response to the measurement result of the second-type frequency point meeting a second reporting condition; or

during running of the first timer, the first communication device stopping the first timer and transmitting the first measurement report in response to the measurement result of the serving cell meeting the second threshold.

In some examples, in response to the measurement result of the first-type frequency point meeting the first reporting condition, the first communication device may start the first timer.

For example, in response to the first timer timing out, the first communication device may transmit the first measurement report to the second communications device. The first measurement report may include the measurement result of the first-type frequency point, and may also include another measurement result of the first communication device during the running of the first timer, such as the measurement result of the second-type frequency point or a measurement state of the second-type frequency point.

As another example, in response to the first timer timing out, the first communication device may determine again whether the measurement result of the first-type frequency point still meets the first reporting condition, and if so, transmit the first measurement report to the second communication device. In this way, in a case where the measurement result of the first-type frequency point no longer meets the first reporting condition during the running of the first timer, the first measurement report does not need to be reported, thereby reducing redundant information or erroneous information.

As another example, during running of the first timer, the first communication device may measure the second-type frequency point. In response to the measurement result of the second-type frequency point meeting the second reporting condition, the first communication device may stop the first timer and transmit the first measurement report. The first measurement report may include the measurement result of the first-type frequency point and the measurement result of the second-type frequency point.

As another example, during running of the first timer, the first communication device may measure the serving cell. In response to the measurement result of the serving cell meeting the second threshold, the first communication device may stop the first timer and transmit the first measurement report. The first measurement report may include the measurement result of the first-type frequency point and the measurement result of the serving cell or the measurement state of the second-type frequency point.

Manner 3: in response to the measurement result of the first-type frequency point meeting the first reporting condition, the first communication device determines whether to transmit the first measurement report based on at least one of the network indication, the priority of the first-type frequency point, or a measurement result of a cell at the first-type frequency point.

In an implementation, first-type frequency point configuration includes first indication information, or first indication information in first-type of frequency configuration is a true value; the first indication information is used for indicating whether the first communication device is allowed to directly report the first measurement report in response to the first-type frequency point meeting the first reporting condition. For example, the first indication information is a true value, representing that the first measurement report is allowed to be directly reported in response to the first-type frequency point meeting the first reporting condition; the first indication information is a false value, representing that the first measurement report is not allowed to be directly reported in response to the first-type frequency point meeting the first reporting condition, and it is necessary to wait until the first condition is met before reporting the first measurement report.

In an implementation, the first-type frequency point configuration is included in a first frequency point list, the first frequency point list is included in the first measurement configuration, and the first frequency point list includes one or more frequency points at which the first communication device directly transmits the first measurement report in a case where the reporting condition is met.

For example, the first measurement configuration received by the first communication device from the second communication device includes the first frequency point list. In response to the measurement result of the first-type frequency point configured in the first frequency point list meeting the first reporting condition, the first communication device may directly transmit the first measurement report.

In an implementation, the priority of the first-type frequency point is not lower than a priority threshold, and the first communication device transmits the first measurement report in a case where the first reporting condition is met.

In an implementation, the method further includes: in response to multiple measurement frequency points included in the first-type frequency point meeting the first reporting condition, a frequency point with a highest priority (hereinafter referred to as priority) among the multiple measurement frequency points being used for comparison with the priority threshold. For example, the first-type frequency point includes measurement frequency points F1, F2, and F3, where the F2 has the highest priority. In this case, the priority of the F2 may be compared with the priority threshold indicated in the first measurement configuration. In response to the priority of the F2 meeting the threshold, for example, being higher than the threshold, the first communication device transmits the first measurement report.

In an implementation, a cell meeting the first reporting condition at the first-type frequency point is a cell specified by the network or a cell included in a cell list specified by the network. For example, there are a cell C1, cell C2, and cell C3 at the first-type frequency point, where the cell C3 is a cell specified by the network in the first measurement configuration. In a case where a measurement result of the cell C3 meets the reporting threshold, it may be considered that the first-type frequency point meets the first reporting condition. In a case where the cell C2 meets the reporting threshold but the cell C3 does not meet the reporting threshold, it may be considered that the first-type frequency point does not meet the first reporting condition.

In an implementation, the number of cells meeting the first reporting condition at the first-type frequency point is not less than the number of cells pre-configured by the network. For example, the number of cells pre-configured by the network is 3, and there are 5 cells at the first-type frequency point in total. In a case where 3 cells meet the first reporting condition, it may be considered that the first-type frequency point meets the first reporting condition. In a case where only two or one cell meets the first reporting condition, it may be considered that the first-type frequency point does not meet the first reporting condition.

In an implementation, cells meeting the first reporting condition at the first-type frequency point are included in the cell list specified by the network. For example, in a case where the cell list specified by the network includes the cells C1, C2, and C3 at the first-type frequency point, and the cell C1 meets the first reporting condition, it may be considered that the first-type frequency point meets the first reporting condition. In a case where only the cell C4 at the first-type frequency point meets the first reporting condition, but the cell C4 is not in the specified cell list, it may be considered that the first-type frequency point does not meet the first reporting condition.

In the embodiments of the present disclosure, a cell category, the number of cells, a cell, etc. may be indicated in the first measurement configuration or in other information.

In an implementation, the first measurement report includes at least one of following: a measurement result of the first-type frequency point; a measurement state of the first-type frequency point; a measurement result of the second-type frequency point; or a measurement state of the second-type frequency point.

In the embodiments of the present disclosure, in a case where the first-type frequency point meets the first reporting condition, the first communication device determines whether to transmit the first measurement report based on the first condition, and determines the content of the transmitted first measurement report based on a second condition. The second condition may be the same as, partially the same as, or completely different from the first condition.

In an implementation, the measurement state of the second-type frequency point includes at least one of following:

whether measurement being performed on the second-type frequency point; or

whether the measurement result of the second-type frequency point meeting an entering state.

In an implementation, the second condition of the first measurement report including the measurement result of the second-type frequency point and/or the measurement state of the second-type frequency point includes at least one of following:

the measurement result of the second-type frequency point meeting a fourth threshold;

a difference between the measurement result of the first-type frequency point and the measurement result of the second-type frequency point meeting a fifth threshold; or

determining, based on a network indication, that the first communication device needs to report the measurement result of the second-type frequency point simultaneously while reporting the measurement result of the first-type frequency point.

In the embodiments of the present disclosure, the first threshold in the first condition and the fourth threshold in the second condition may be the same or different. The third threshold in the first condition and the fifth threshold in the second condition may be the same or different.

For example, in a case where the first-type frequency point meets the first reporting condition and the measurement result of the second-type frequency point meets the second threshold and the fourth threshold, the first measurement report transmitted by the first communication device to the second communication device includes the measurement result of the second-type frequency point and/or the measurement state of the second-type frequency point.

For example, in a case where the first-type frequency point meets the first reporting condition, and the difference between the measurement result of the first-type frequency point and the measurement result of the second-type frequency point meets the third threshold and the fifth threshold, the first measurement report transmitted by the first communication device to the second communication device includes the measurement result of the second-type frequency point and/or measurement state of the second-type frequency point.

As another example, in a case where the first-type frequency point meets the first reporting condition and currently meets any one of first conditions, and the network indicates the first communication device to report the measurement result of the second-type frequency point while reporting the measurement result of the first-type frequency point, the first measurement report transmitted by the first communication device to the second communication device includes the measurement result of the second-type frequency point and/or measurement state of the second-type frequency point.

In an implementation, a relationship between the first-type frequency point and the second-type frequency point includes:

a priority of the first-type frequency point being lower than a priority of the second-type frequency point;

the first-type frequency point and the second-type frequency point are all frequency points in a frequency point list; and

the first-type frequency point and the second-type frequency point are respectively included in a second frequency point list and a third frequency point list that are pre-configured by the network.

For example, the network configures a frequency point universal set that needs to be measured for the terminal. The network further indicates which frequency point(s) in the frequency point universal set need to be reported based on the first condition, then the frequency point(s) may be understood as first-type frequency point. Except for the first-type frequency point, other frequency points in the frequency point universal set may all be understood as the second-type frequency point. Conversely, the network may indicate that which frequency point(s) belong to the second-type frequency point, and the other frequency points in the frequency point set belong to the first-type frequency point.

As another example, the second-type frequency point is a frequency point with the higher priority than the first-type frequency point. For example, the first-type frequency point is F1, and its priority is 2. Then, the other frequency points in the frequency point list with a priority higher than 2 are all the second-type frequency point. In a case where the first-type frequency point meets the first reporting condition, and the measurement result of the second-type frequency point does not meet the second reporting condition, the first communication device determines that the reported the first measurement report includes the measurement result of the second-type frequency point and/or the measurement state of the second-type frequency point, or the first communication device determines whether the first measurement report includes the measurement result of the second-type frequency point and/or the measurement state of the second-type frequency point based on the second condition, which is conducive to feeding back the measurement result of the measurement frequency point and/or the measurement state of the measurement frequency point with high priority to the second communication device, and helps the second communication device to determine whether to perform operations such as handover or cell change based on the measurement result of the first-type frequency point.

As another example, the frequency point list pre-configured by the network includes a frequency point F1, frequency point F2, frequency point F3, frequency point F4, and frequency point F5 that need to be measured. In a case where the first-type frequency point include the frequency point F1 and the frequency point F3, other frequency points in the frequency point list except the first frequency points F1 and F3 are second-type frequency points, including the frequency point F2, the frequency points F4 and the frequency points F5. In a case where the frequency point F1 and/or the frequency point F3 meets the first reporting condition, the first communication device determines whether the first measurement report includes the measurement result of the second-type frequency point and/or the measurement state of the second-type frequency point based on the second condition, which is conducive to reporting a measurement result and/or measurement state of the frequency point of interest to the network.

As another example, the second frequency point list pre-configured by the network includes the first-type frequency point, and the third frequency point list pre-configured by the network may include the second-type frequency point. In a case where the first-type frequency point in the second frequency point list meets the first reporting condition, the first communication device determines whether to report the first measurement report based on the first condition. The first communication device determines whether the first measurement report includes the measurement result of the second-type frequency point and/or the measurement state of the second-type frequency point based on the second condition. In a case where the first measurement report needs to include the measurement result and/or measurement state of the second-type frequency point, the second-type frequency point may be determined from the third frequency point list, which is conducive to reporting a measurement result and/or measurement state of the frequency point of interest to the network.

In an implementation, a manner for determining a priority relationship between the first-type frequency point and the second-type frequency point includes at least one of following:

a manner based on priority configuration associated with the first-type frequency point and the second-type frequency point, the priority configuration including an index value for representing a priority associated with each measurement frequency point in the first-type frequency point and the second-type frequency point; or

a manner based on an order of the first-type frequency point and the second-type frequency point in a measurement frequency point list.

In a case, the larger the index value used for representing the priority, the higher the priority of the measurement frequency point. For example, priority 5 is greater than priority 3. In another case, the larger the index value used for representing the priority, the lower the priority of the measurement frequency point. For example, priority 3 is greater than priority 5.

In some examples, the measurement frequency point list includes a frequency point F1, a frequency F2, and a frequency F3 in sequence, where the priority of the frequency F1 is higher than that of the frequency F2, and the priority of the frequency F2 is higher than that of the frequency F3.

In an implementation, the measurement result of the first-type frequency point and/or the measurement result of the second-type frequency point includes at least one of following:

a measurement result of a cell with a largest measurement parameter among multiple cells;

measurement results of one or more cells that meet the first reporting condition; or

measurement results of one or more cells that meet a second reporting condition.

In an implementation, the measurement parameter includes at least one of RSRP, RSRQ, or SINR.

In an implementation, the measurement result of the second-type frequency point includes measurement results of A cells at the second-type frequency point, where the A cells includes A cells with optimal measurement results, or A cells with randomly selected measurement results; A being greater than or equal to 1.

For example, there are N cells at the second-type frequency point, and measurement results of the top A cells ranked by measurement results may be reported through the first measurement report. Here, N is greater than or equal to A.

In an implementation, the first-type frequency point and/or the second-type frequency point includes multiple measurement frequency points, and the measurement result of the first-type frequency point and/or the measurement result of the second-type frequency point includes B frequency points with optimal measurement results among the multiple measurement frequency points, or C frequency points with highest priority among the multiple measurement frequency points; B being greater than or equal to 1, and C being greater than or equal to 1.

For example, there are R cells at the first-type frequency point, and the measurement results of the top B cells ranked by measurement results or the C frequency points with the highest priority may be reported in the first measurement report. Here, R is greater than or equal to B, and R is greater than or equal to C. There are N cells at the second-type frequency point, and the measurement results of the top B cells ranked by measurement results or the measurement results of the C frequency points with the highest priority may be reported through the first measurement report. Here, N is greater than or equal to B, and N is greater than or equal to C.

In an implementation, a manner for selecting the second-type frequency point includes at least one of following: all or part of frequency points in a frequency point to be measured list except the first-type frequency point; all or part of frequency points in a frequency point to be measured list that have a high priority than the first-type frequency point; all or part of frequency points in a frequency point list pre-configured by a network; M frequency points with optimal measurement results; or M frequency points determined in an descending order of priority; M being greater than or equal to 1.

For example, the frequency point to be measured list includes a frequency point F1, a frequency point F2, and a frequency point F3. Here, the frequency point F1 is the first-type frequency point, and the others belong to the second type of frequency. As another example, the frequency point to be measured list may include the priority of each frequency point. In a case where the frequency point F1 is a first-type frequency point, the frequency point F2 with a higher priority than the frequency point F1 may be the second-type frequency point. As another example, in a case where the frequency point list pre-configured by the network includes a frequency point F2, a frequency point F3, and a frequency F5, the frequency point F1 is the first-type frequency point, and the frequency point F2, the frequency point F3, and the frequency point F5 in the frequency point list may be the second-type frequency point. As another example, the frequency point F1 is the first-type frequency point, and M frequency points with a higher priority than the F1 are regarded as the second-type frequency point. Alternatively, among the frequency points with a priority higher than the F1, M frequency points are selected as the second-type frequency point in descending order of the priority.

In the embodiments of the present disclosure, the frequency point to be measured list and the frequency point list pre-configured by the network may be the same as or different from each other. The frequency point to be measured list and the frequency point list pre-configured by the network may be carried by the first measurement configuration or by other information.

FIG. 6 is a schematic flowchart of a communication method 600 according to an embodiment of the present disclosure. This method may optionally be applied to a system illustrated in FIG. 1, but is not limited thereto. The method includes at least part of following.

In S610, a second communication device transmits a first measurement configuration, where the first measurement configuration is used for assisting a first communication device in determining whether to transmit a first measurement report based on a first condition in response to a first-type frequency point meeting a first reporting condition.

In an implementation, a cell meeting the first reporting condition at the first-type frequency point is a cell specified by a network, or a cell included in a cell list specified by a network.

In an implementation, the number of cells meeting the first reporting condition at the first-type frequency point is not less than a number of cells pre-configured by a network.

In an implementation, cells meeting the first reporting condition at the first-type frequency point are included in a cell list specified by a network.

In an implementation, the first measurement configuration includes at least one of following: a threshold related to a measurement result; a first timer duration; a priority threshold; a first frequency point list; first indication information; or a cell list.

In an implementation, the first frequency point list includes one or more frequency points at which the first communication device directly transmits the first measurement report in response to the reporting condition being met.

In an implementation, the first frequency point list includes first-type frequency point configuration, the first-type frequency point configuration includes first indication information, or first indication information in the first-type frequency point configuration is a true value;

where the first indication information is used for indicating that whether the first communication device is allowed to directly report the first measurement report in response to the first-type frequency point meeting the first reporting condition.

FIG. 7 is a schematic flowchart of a communication method 700 according to another embodiment of the present disclosure. The method may include one or more features of the above communication method. In an implementation, the method further includes:

S710, receiving, by the second communication device, the first measurement report transmitted by the first communication device in response to the first-type frequency point meeting the first reporting condition and the first condition being met.

In an implementation, the first condition includes at least one of following: a measurement result of a second-type frequency point meeting a first threshold; a first timer timing out; a measurement result of a current serving cell meeting a second threshold; a difference between a measurement result of a first-type frequency point and a measurement result of a second-type frequency point meeting a third threshold; determining, based on a network indication, that the first-type frequency point is a frequency point at which a measurement result is allowed to be directly reported in response to a reporting condition being met; a priority of the first-type frequency point being not lower than a priority threshold; a first cell at the first-type frequency point meeting a reporting condition; at least N cells that meet a reporting condition at the first-type frequency point existing, N being a positive integer; or it being predicted that measurement reporting of a second-type frequency point will be triggered within a first-time window.

In an implementation, the first measurement report includes at least one of following: a measurement result of the first-type frequency point; a measurement state of the first-type frequency point; a measurement result of the second-type frequency point; or a measurement state of the second-type frequency point.

In an implementation, the measurement state of the second-type frequency point includes at least one of following:

whether measurement being performed on the second-type frequency point; or

whether the measurement result of the second-type frequency point meeting an entering state.

In an implementation, the second condition of the first measurement report including the measurement result of the second-type frequency point and/or a measurement state of the second-type frequency point includes at least one of following:

the measurement result of the second-type frequency point meeting a fourth threshold;

a difference between the measurement result of the first-type frequency point and the measurement result of the second-type frequency point meeting a fifth threshold; or

determining, based on the network indication, that the first communication device needs to report the measurement result of the second-type frequency point while reporting the measurement result of the first-type frequency point.

In an implementation, the relationship between the first-type frequency point and the second-type frequency point includes:

a priority of the first-type frequency point being lower than a priority of the second-type frequency point;

the first-type frequency point and the second-type frequency point being all frequency points in a frequency point list; and

the first-type frequency point and the second-type frequency point being respectively included in a second frequency point list and third frequency point list that are pre-configured by the network.

In an implementation, a manner for determining a priority relationship between the first-type frequency point and the second-type frequency point includes at least one of following:

a manner based on priority configuration associated with the first-type frequency point and the second-type frequency point, the priority configuration including an index value for representing a priority associated with each measurement frequency point in the first-type frequency point and the second-type frequency point; or

a manner based on an order of the first-type frequency point and the second-type frequency point in a measurement frequency point list.

In an implementation, the measurement result of the first-type frequency point and/or the measurement result of the second-type frequency point includes at least one of following:

a measurement result of a cell with a largest measurement parameter among multiple cells;

measurement results of one or more cells that meet the first reporting condition; or

measurement results of one or more cells that meet a second reporting condition.

In an implementation, the measurement parameter includes at least one of RSRP, RSRQ, or SINR.

In an implementation, the measurement result of the second-type frequency point includes measurement results of A cells at the second-type frequency point, where the A cells include A cells with optimal measurement results, or A cells with randomly selected measurement results; A being greater than or equal to 1.

In an implementation, the first-type frequency point and/or the second-type frequency point includes multiple measurement frequency points, and the measurement result of the first-type frequency point and/or the measurement result of the second-type frequency point includes B frequency points with optimal measurement results among the multiple measurement frequency points, or C frequency points with highest priority among the multiple measurement frequency points; B being greater than or equal to 1, and C being greater than or equal to 1.

In an implementation, a manner for selecting the second-type frequency point includes at least one of following: all or part of frequency points in a frequency point to be measured list except the first-type frequency point; all or part of frequency points in a frequency point to be measured list that have a higher priority than the first-type frequency point; all or part of frequency points in a frequency point list pre-configured by a network; M frequency points with optimal measurement results; or M frequency points determined in an descending order of priority; M being greater than or equal to 1.

The specific examples of the second communication device performing the methods 600 and 700 in the embodiments may be refer to the relevant descriptions of the second communication device, such as a base station, in the above methods 400 and 500, which will not be repeated here for the sake of brevity.

In some examples, the communication method of the embodiments of the present disclosure may include following.

1. The UE transmits a first measurement report to the network in response to a first condition being met. Examples of the first condition may include at least one of following.

a) A measurement result of a first-type frequency point meets a reporting condition. For example, the reporting condition includes events A1-A6, B1, and B2.

b) A measurement result of a second-type frequency point is less than or equal to a first threshold.

c) A first timer times out.

d) A measurement result of a current serving cell is less than or equal to a second threshold.

e) A difference between a measurement result of a first-type frequency point and a measurement result of a second-type frequency point is greater than, equal to, or less than a third threshold.

f) Based on the network indication, it is determined that a first-type frequency point is a frequency point at which a measurement result is allowed to be directly reported in response to a reporting condition being met. The network indication may be a per-UE indication or a per-frequency point indication. In a case where it is the per-UE indication, the indication is applied to all frequency points. In a case where it is the per-frequency point indication, only the frequency point associated with the corresponding indication is applicable.

g) A priority of the first-type frequency point is not be lower than the pre-configured priority.

h) A first cell at the first-type frequency point meets a reporting condition, where the first cell is configured by the network.

i) At least N cells that meet a reporting condition at the first-type frequency point exist.

g) It is predicted that measurement reporting of a second-type frequency point will be triggered within a first-time window.

2. The first measurement report may include a measurement result/measurement state of the first-type frequency point, and/or a measurement result/measurement state of the second-type frequency point.

3. In a case where a second condition is met, the first measurement report reported by the UE may include the measurement result of the second-type frequency point. Examples of the second condition may include at least one of following.

a) The measurement result of the second-type frequency point meets the fourth threshold.

b) A difference between the measurement result of the first-type frequency point and the measurement result of the second-type frequency point does not exceed a fifth threshold.

c) Based on the network indication, the UE need to report the measurement result of the second-type frequency point while reporting the measurement result of the first-type frequency point. The indication may be a UE-based (per UE) indication or a frequency-based (per frequency) indication.

4. The first measurement report may further include the measurement state of the second-type frequency point. For example, examples of the measurement state may include at least one of following.

a) Whether measurement being performed on the second-type frequency point.

b) Whether the measurement result of the second-type frequency point meets an entering state (entering conditions).

5. The first-type frequency point and the second-type frequency point each include at least one frequency point. Examples of the relationship between the first-type frequency point and the second-type frequency point may include at least one of following.

a) The priority of the first-type frequency point is lower than that of the second-type frequency point.

b) The first-type frequency point and the second-type frequency point are all the frequency points in a frequency point list.

c) The first frequency point and the second frequency point are respectively included in a first frequency point list and second frequency point list that are pre-configured by the network.

6. The priority relationship between the first-type frequency point and the second-type frequency point is determined by one or more of following manners.

a) A manner based on priority configuration associated with the first-type frequency point and the second-type frequency point. For example, each frequency point is associated with an index value that represent the priority.

b) A manner based on an order of the first-type frequency point and the second-type frequency point in a measurement frequency point list.

7. The measurement result of the first-type frequency point/ second-type frequency point is a measurement result of a cell with the maximum RSRP, RSRQ or SINR at the first-type frequency point/second-type frequency point.

Example I: based on the measurement result of the second-type frequency point or the measurement result of the current serving cell, it is determined whether to transmit the first measurement report to the network in response to the first-type frequency point meeting the reporting condition.

1. The UE receives a first measurement configuration transmitted by a network side, and performs, based on the first measurement configuration, measurement on at least one frequency point. For example, frequency points to be measured include the first-type frequency point and the second-type frequency point, and it is assumed that the reporting condition corresponding to the first-type frequency point is a first reporting condition, and the reporting condition corresponding to the second-type frequency point is a second reporting condition.

2. In response to the measurement result of the first-type frequency point meeting the first reporting condition, the UE further determines whether to transmit the first measurement report to the network based on the measurement result of the second-type frequency point. For example, following situations may be included:

a) in response to the measurement result of the second-type frequency point being less than/equal to the first threshold, the UE transmitting the first measurement report to the network; or

b) in response to the difference between the measurement result of the second-type frequency point and the measurement result of the first-type frequency point being greater than/equal to the third threshold, the UE transmitting the first measurement report to the network; or

c) in response to the measurement result of the current serving cell being less than/equal to the second threshold, the UE transmitting the first measurement report to the network.

Optionally, in a case where the first-type frequency point and/or the second-type frequency point includes multiple measurement frequency points, the first-type frequency point and the second-type frequency point in S520 are frequency points with the optimal measurement results among the multiple frequency points, or frequency points with the highest priority among the multiple frequency points.

Example II: based on the running state of the timer, it is determined whether to transmit the first measurement report.

1. The UE receives a first measurement configuration transmitted by the network side, and performs, based on the first measurement configuration, measurement on the first-type frequency point and the second-type frequency point. It is assumed that the reporting condition corresponding to the first-type frequency point is the first reporting condition, and the reporting condition corresponding to the second-type frequency point is the second reporting condition.

2. In response to the measurement result of the first-type frequency point meeting the first reporting condition, the UE starts the first timer. In response to the first timer timing out, the UE transmits the first measurement report to the network. Optionally, in a case where the first timer times out, and the measurement result of the first-type frequency point still meets the first reporting condition, the first measurement report is transmitted to the network.

During the running of the first timer, in response to the measurement result of the second-type frequency point meeting the second reporting condition, the UE stops the first timer and transmits the first measurement report to the network. Alternatively, during the running of the first timer, in response to the measurement result of the serving cell being less than/equal to the second threshold, the UE stops the first timer and transmits the first measurement report to the network.

Example III: based on the priority of the first-type frequency point and/or the measurement result of a cell at the first-type frequency point, it is determined whether to transmit the first measurement report to the network in response to the reporting condition being met.

1. The UE receives a first measurement configuration transmitted by the network side, and performs, based on the first measurement configuration, measurement on the first-type frequency point and the second-type frequency point. It is assumed that the reporting condition corresponding to the first-type frequency point is the first reporting condition, and the reporting condition corresponding to the second-type frequency point is the second reporting condition.

2. In response to the measurement result of the first-type frequency point meeting the first reporting condition, the UE further determines whether to transmit the first measurement report to the network based on at least one of following: a network indication, and/or a priority of the first-type frequency point, and/or a measurement result of a cell at the first-type frequency point. Specific examples include that:

a) the first-type frequency point configuration includes first indication information, or the first indication information in the first-type frequency point configuration is set to a true value (true); the first indication information is used for indicating whether the UE directly reports the first measurement report to the network in response to the first-type frequency point meeting the first reporting condition; or

b) the first-type frequency point configuration is included in a first frequency point list, and the first frequency point list is included in the first measurement configuration; the first-type frequency point configuration is used for indicating that the UE directly transmits the first measurement report at which frequency points to the network in response to the reporting condition being met; or

c) the priority of the first-type frequency point is not lower than the pre-configured priority; for example, the priority of the first-type frequency point is 3, and the priority pre-configured by the network is 5, 3 being greater than 5 (3>5), then the UE may transmit the first measurement report to the network in response to the first reporting condition being met. Optionally, in a case where the first-type frequency point includes multiple frequency points, a frequency point with the highest priority among the multiple frequency points is selected for comparison with the pre-configured priority; or

d) a cell meeting the reporting condition at the first-type frequency point is a cell specified by the network, or is included in a cell list specified by the network; or

e) the number of cells meeting the reporting condition at the first-type frequency point is not less than the number of cells pre-configured by the network; for example, the number pre-configured by the network is 3, and the number of cells meeting the reporting conditions at the first-type frequency point is 4, 4 being greater than 3 (4>3), then the UE transmits the first measurement report to the network. Optionally, cells that meet the reporting conditions needed to be included in a cell list specified by the network.

3. Optionally, in a case where the first-type of frequency point includes multiple measurement frequency points, all of the multiple frequency points are needed to meet the condition in 2, or at least one of the multiple frequency points is needed to meet the condition in 2, or a frequency point with the highest priority among the multiple frequency points is needed to meet the condition in 2.

Example IV: the content of the first measurement report is determined.

1. The UE determines to transmit the first measurement report to the network based on the first condition. The first measurement report includes at least the measurement result of the first-type frequency point and, and includes the measurement result and/or the measurement state of the second-type frequency point in a case where following conditions are met:

a) based on network indication, the first measurement configuration from the network indicating whether the UE needs to report the measurement result of the second-type frequency point simultaneously while reporting the measurement result of the first-type frequency point;

b) in response to the difference between the measurement result of the first-type frequency point and the measurement result of the second-type frequency point not exceeding a fifth threshold, the UE determining that the first measurement report includes the measurement result of the first-type frequency point and the measurement result/the measurement state of the second-type frequency point.

2. All/part of the frequency points in the frequency point to be measured list except the first-type frequency point are the second-type frequency point, or all/part of the frequency points with a higher priority than the first-type frequency point are the second-type frequency point, or all or part of the frequency points in the frequency point list pre-configured by the network are the second-type frequency point. For example, in response to the first measurement configuration from the network including frequency point list #1, the UE needs to report the measurement results/measurement states of all frequency points in the frequency point list #1 while reporting the measurement result of the first-type frequency point, or the UE only reports a measurement result/measurement state of a frequency point in frequency point list #1 that have a higher priority than the first-type frequency point. In another implementation, the selected part of the frequency points is M frequency points with the optimal measurement results, or M frequency points determined in descending order of priority.

3. Optionally, the measurement result of the second-type frequency point includes measurement results of N cells at the second-type frequency point, N corresponding to N cells with the optimal measurement results, or measurement results of N randomly selected cells.

4. Optionally, in a case where the first-type frequency point includes multiple measurement frequency points, the first measurement report includes the measurement result of the frequency point with the highest priority among the multiple frequency points, or the measurement results of X frequency points in order of priority are reported.

The communication methods in the embodiments of the present disclosure may include a method for reporting the measurement result based on priority configuration. According to the solutions provided in the embodiments of the present disclosure, it is possible to ensure that the network may obtain the measurement result and measurement state of the frequency point with high priority as much as possible without affecting communications.

FIG. 8 is a schematic block diagram of a first communication device 800 according to an embodiment of the present disclosure. The first communication device 800 may include:

a transmitting unit 810 configured to determine, in response to a first-type frequency point meeting a first reporting condition, whether to transmit a first measurement report based on a first condition.

In an implementation, the transmitting unit is further configured to transmit the first measurement report in response to the first condition being met.

FIG. 9 is a schematic block diagram of a first communication device 900 according to another embodiment of the present disclosure. The device may include one or more features of the above first communication device. In an implementation, the first communication device 900 further includes:

a receiving unit 910 configured to receive a first measurement configuration; and

a processing unit 920 configured to perform measurement on a first-type frequency point and/or a second-type frequency point based on the first measurement configuration.

In an implementation, the first measurement configuration includes at least one of following: a threshold related to a measurement result; a first timer duration; a priority threshold; a first frequency point list; first indication information; or a cell list.

In an implementation, the first condition includes at least one of following:

a measurement result of a second-type frequency point meeting a first threshold;

a first timer timing out;

a measurement result of a current serving cell meeting a second threshold;

a difference between a measurement result of the first-type frequency point and a measurement result of the second-type frequency point meeting a third threshold;

determining, based on a network indication, that the first-type frequency point is a frequency point at which a measurement result is allowed to be directly reported in response to a reporting condition being met;

a priority of the first-type frequency point being not lower than a priority threshold;

a first cell at the first-type frequency point meeting a reporting condition;

at least N cells at the first-type frequency point that meet a reporting condition existing, N being a positive integer; or

it being predicted that measurement reporting at a second-type frequency point will be triggered within a first-time window.

In an implementation, the transmitting unit 810 is further configured to enable the first communication device to determine, in response to the measurement result of the first-type frequency point meeting the first reporting condition, whether to transmit the first measurement report based on the measurement result of the second-type frequency point.

In an implementation, in response to the measurement result of the first-type frequency point meeting the first reporting condition, the first communication device determining whether to transmit the first measurement report based on the measurement result of the second-type frequency point includes at least one of following:

the first communication device transmitting the first measurement report in response to the measurement result of the second-type frequency point meeting the first threshold;

the first communication device transmitting the first measurement report in response to the difference between the measurement result of the second-type frequency point and the measurement result of the first-type frequency point meeting the third threshold; or

the first communication device transmitting the first measurement report in response to the measurement result of the current serving cell meeting the second threshold.

In an implementation, the transmitting unit 810 is further configured to enable the first communication device to start, in response to the measurement result of the first-type frequency point meeting the first reporting condition, a first timer; and determine whether to transmit the first measurement report based on a state of the first timer.

In an implementation, determining whether to transmit the first measurement report based on the state of the first timer includes at least one of following:

the first communication device transmitting the first measurement report in response to the first timer timing out;

the first communication device transmitting the first measurement report in response to the first timer timing out and the measurement result of the first-type frequency point meeting the first reporting condition;

during running of the first timer, the first communication device stopping the first timer and transmitting the first measurement report in response to the measurement result of the second-type frequency point meeting a second reporting condition; or

during running of the first timer, the first communication device stopping the first timer and transmitting the first measurement report in response to the measurement result of the serving cell meeting the second threshold.

In an implementation, the transmitting unit 810 is further configured to enable the first communication device to determine, in response to the measurement result of the first-type frequency point meeting the first reporting condition, whether to transmit the first measurement report based on at least one of the network indication, the priority of the first-type frequency point, or a measurement result of a cell at the first-type frequency point.

In an implementation, the first-type frequency point configuration includes first indication information, or first indication information in first-type frequency point configuration is a true value;

where the first indication information is used for indicating whether the first communication device is allowed to directly report the first measurement report in response to the first-type frequency point meeting the first reporting condition.

In an implementation, the first-type frequency point configuration is included in a first frequency point list, the first frequency point list is included in a first measurement configuration, and the first frequency point list includes one or more frequency points at which the first communication device directly transmits the first measurement report in response to the reporting condition being met.

In an implementation, the priority of the first-type frequency point is not lower than the priority threshold, and the first communication device transmits the first measurement report in response to the first reporting condition being met.

In an implementation, the first communication device further includes: in response to the first-type frequency point including multiple measurement frequency points, a frequency point with a highest priority among the multiple measurement frequency points being used for comparison with the priority threshold.

In an implementation, a cell meeting the first reporting condition at the first-type frequency point is a cell specified by the network or a cell included in a cell list specified by the network.

In an implementation, a number of cells meeting the first reporting condition at the first-type frequency point is not less than a number of cells pre-configured by the network.

In an implementation, a cell meeting the first reporting condition at the first-type frequency point is included in a cell list specified by the network.

In an implementation, the first measurement report includes at least one of following: a measurement result of the first-type frequency point; a measurement state of the first-type frequency point; a measurement result of the second-type frequency point; or a measurement state of the second-type frequency point.

In an implementation, the measurement state of the second-type frequency point includes at least one of following:

whether measurement being performed on the second-type frequency point; or

whether the measurement result of the second-type frequency point meeting an entering state.

In an implementation, a second condition of the first measurement report including the measurement result of the second-type frequency point and/or the measurement state of the second-type frequency point includes at least one of following:

the measurement result of the second-type frequency point meeting a fourth threshold;

a difference between the measurement result of the first-type frequency point and the measurement result of the second-type frequency point meeting a fifth threshold; or

determining, based on a network indication, that the first communication device needs to report the measurement result of the second-type frequency point while reporting the measurement result of the first-type frequency point.

In an implementation, a relationship between the first-type frequency point and the second-type frequency point includes:

a priority of the first-type frequency point being lower than a priority of the second-type frequency point;

the first-type frequency point and the second-type frequency point being all frequency points in a frequency point list; and

the first-type frequency point and the second-type frequency point being respectively included in a second frequency point list and a third frequency point list that are pre-configured by the network.

In an implementation, a manner for determining a priority relationship between the first-type frequency point and the second-type frequency point includes at least one of following:

a manner based on priority configuration associated with the first-type frequency point and the second-type frequency point, the priority configuration including an index value for representing a priority associated with each measurement frequency point in the first-type frequency point and the second-type frequency point; or

a manner based on an order of the first-type frequency point and the second-type frequency point in a measurement frequency point list.

In an implementation, the measurement result of the first-type frequency point and/or the measurement result of the second-type frequency point includes at least one of following:

a measurement result of a cell with a largest measurement parameter among multiple cells;

measurement results of one or more cells that meet the first reporting condition; or

measurement results of one or more cells that meet a second reporting condition.

In an implementation, the measurement parameter includes at least one of RSRP, RSRQ, or SINR.

In an implementation, the measurement result of the second-type frequency point includes measurement results of A cells at the second-type frequency point; the A cells include A cells with optimal measurement results, or A cells with randomly selected measurement results; A being greater than or equal to 1.

In an implementation, the first-type frequency point and/or the second-type frequency point includes multiple measurement frequency points, and the measurement result of the first-type frequency point and/or the measurement result of the second-type frequency point includes B frequency points with optimal measurement results among the multiple measurement frequency points, or C frequency points with highest priority among the multiple measurement frequency points; B being greater than or equal to 1, and C being greater than or equal to 1.

In an implementation, a manner for selecting the second-type frequency point includes at least one of following: all or part of frequency points in a frequency point to be measured list except the first-type frequency point; all or part of frequency points in a frequency point to be measured list that have a high priority than the first-type frequency point; all or part of frequency points in a frequency point list pre-configured by a network; M frequency points with optimal measurement results; or M frequency points determined in an descending order of priority; M being greater than or equal to 1.

The first communication devices 800 and 900 in the embodiments of the present disclosure may implement the corresponding functions of the first communication device in the above method embodiments. The processes, functions, implementation methods and beneficial effects corresponding to various modules (sub-modules, unit or components, or the like) in the first communication devices 800, 900 may be referred to the corresponding description in the above method embodiments, which will not be repeated here. It should be noted that the functions described in the various modules (sub-modules, units or components, or the like) in the first communication devices 800 and 900 of the disclosure embodiments may be implemented by different modules (sub-modules, units or components, or the like) or by the same module (sub-module, unit or component, or the like).

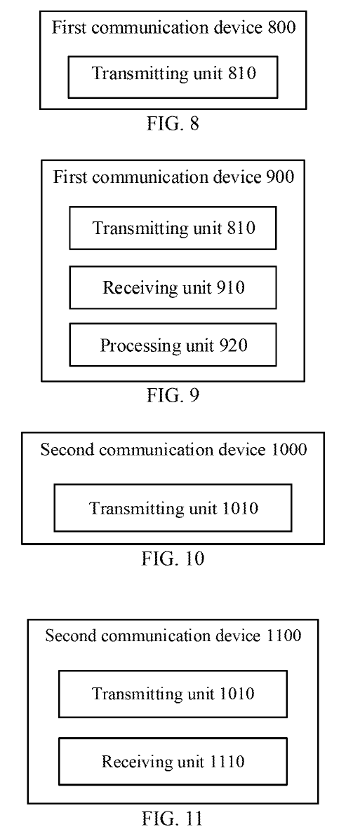

FIG. 10 is a schematic block diagram of a second communication device 1000 according to an embodiment of the present disclosure. The second communication device 1000 may include:

a transmitting unit 1010, configured to transmit a first measurement configuration, where the first measurement configuration is used for assisting a first communication device in determining whether to transmit a first measurement report based on a first condition in response to a first-type frequency point meeting a first reporting condition.

In an implementation, a cell meeting the first reporting condition at the first-type frequency point is a cell specified by a network, or a cell included in a cell list specified by a network.

In an implementation, a number of cells meeting the first reporting condition at the first-type frequency point is not less than a number of cells pre-configured by a network.

In an implementation, cells meeting the first reporting condition at the first-type frequency point are included in a cell list specified by a network.

In an implementation, the first measurement configuration includes at least one of following: a threshold related to a measurement result; a first timer duration; a priority threshold; a first frequency point list; first indication information; or a cell list.

In an implementation, the first frequency point list includes one or more frequency points to which the first communication device directly transmits the first measurement report in response to the reporting condition being met.

In an implementation, a first frequency point list includes a first-type frequency point configuration, and the first-type frequency point configuration includes first indication information, or first indication information in the first-type frequency point configuration is a true value;

where the first indication information is used for indicating whether the first communication device is allowed to directly report the first measurement report in response to the first-type frequency point meeting the first reporting condition.

FIG. 11 is a schematic block diagram of a second communication device 1100 according to another embodiment of the present disclosure. The device may include one or more features of the above second communication device. In an implementation, the second communication device further includes:

a receiving unit 1110, configured to receive the first measurement report transmitted by the first communication device in response to the first-type frequency point meeting the first reporting condition and the first condition being met.

In an implementation, the first condition includes at least one of following:

a measurement result of a second-type frequency point meeting a first threshold;

a first timer timing out;

a measurement result of a current serving cell meeting a second threshold;

a difference between a measurement result of the first-type frequency point and a measurement result of a second-type frequency point meeting a third threshold;

determining, based on a network indication, that the first-type frequency point is a frequency point at which a measurement result is allowed to be directly reported in response to a reporting condition being met;

a priority of the first-type frequency point being not lower than the priority threshold;

a first cell at the first-type frequency point meeting a reporting condition;

at least N cells that meet a reporting condition at the first-type frequency point existing, N being a positive integer; or

it being predicted that measurement reporting at a second-type frequency point will be triggered within a first-time window.

In an implementation, the first measurement report includes at least one of following: the measurement result of the first-type frequency point; a measurement state of the first-type frequency point; the measurement result of the second-type frequency point; or a measurement state of the second-type frequency point.

In an implementation, the measurement state of the second-type frequency point includes at least one of following:

whether measurement being performed on the second-type frequency point; or

whether the measurement result of the second-type frequency point meeting an entering state.

In an implementation, a second condition of the first measurement report including the measurement result of the second-type frequency point and/or the measurement state of the second-type frequency point includes at least one of following:

the measurement result of the second-type frequency point meeting a fourth threshold;

a difference between the measurement result of the first-type frequency point and the measurement result of the second-type frequency point meeting a fifth threshold; or

determining, based on the network indication, that the first communication device needs to report the measurement result of the second-type frequency point while reporting the measurement result of the first-type frequency point.

In an implementation, the relationship between the first-type frequency point and the second-type frequency point includes:

a priority of the first-type frequency point being lower than a priority of the second-type frequency point;

the first-type frequency point and the second-type frequency point being all frequency points in a frequency point list; and

the first-type frequency point and the second-type frequency point being respectively included in a second frequency point list and a third frequency point list that are pre-configured by the network.

In an implementation, a manner for determining a priority relationship between the first-type frequency point and the second-type frequency point includes at least one of following:

a manner based on priority configuration associated with the first-type frequency point and the second-type frequency point, the priority configuration including an index value for representing a priority associated with each measurement frequency point in the first-type frequency point and the second-type frequency point; or

a manner based on an order of the first-type frequency point and the second-type frequency point in a measurement frequency point list.

In an implementation, the measurement result of the first-type frequency point and/or the measurement result of the second-type frequency point includes at least one of following:

a measurement result of a cell with a largest measurement parameter among multiple cells;

measurement results of one or more cells that meet the first reporting condition; or

measurement results of one or more cells that meet a second reporting condition.

In an implementation, the measurement parameter includes at least one of RSRP, RSRQ, or SINR.

In an implementation, the measurement result of the second-type frequency point includes measurement results of A cells at the second-type frequency point, where the A cells include A cells with optimal measurement results, or A cells with randomly selected measurement results; A being greater than or equal to 1.

In an implementation, the first-type frequency point and/or the second-type frequency point includes multiple measurement frequency points, and the measurement result of the first-type frequency point and/or the measurement result of the second-type frequency point includes B frequency points with optimal measurement results among the multiple measurement frequency points, or C frequency points with highest priority among the multiple measurement frequency points; B being greater than or equal to 1, and C being greater than or equal to 1.

In an implementation, a manner for selecting the second-type frequency point includes at least one of following: all or part of frequency points in a frequency point to be measured list except the first-type frequency point; all or part of frequency points in a frequency point to be measured list that have a higher priority than the first-type frequency point; all or part of frequency points in a frequency point list pre-configured by a network; M frequency points with an optimal measurement result; or M frequency points determined in an descending order of priority; and M being greater than or equal to 1.

The second communication devices 1000 and 1100 in the embodiments of the present disclosure may implement the corresponding functions of the second communication device in the above method embodiments. The processes, functions, implementation methods and beneficial effects corresponding to various modules (sub-modules, units or components, or the like) in the second communication devices 1000, 1100 may be found in the corresponding description in the above method embodiments, which will not be repeated here. It should be noted that the functions described in the various modules (sub-modules, units or components, or the like) in the second communication devices 1000 and 1100 of the disclosure embodiments may be implemented by different modules (sub-modules, units or components, or the like) or by the same module (sub-module, unit or component, or the like).

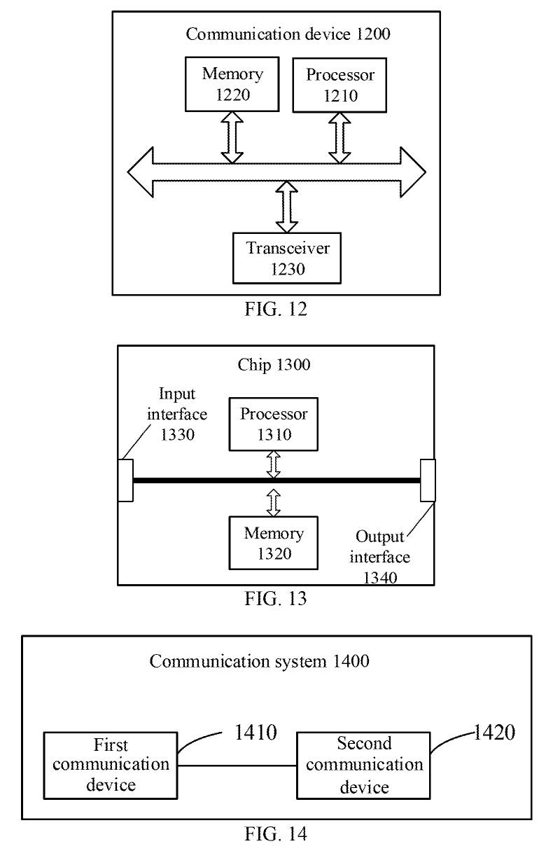

FIG. 12 is a schematic structural diagram of a communication device 1200 according to the embodiments of the present disclosure. The communication device 1200 includes a processor 1210. The processor 1210 may call a computer program from a memory and run the computer program, to enable the communication device 1200 to implement the methods in the embodiments of the present disclosure.

In an implementation, the communication device 1200 may further include a memory 1220. The processor 1210 may call a computer program from the memory 1220 and run the computer program, to enable the communication device 1200 to implement the methods in the embodiments of the present disclosure.

The memory 1220 may be a separate device independent of the processor 1210, or may be integrated into the processor 1210.

In an implementation, the communication device 1200 may further include a transceiver 1230, and the processor 1210 may control the transceiver 1230 to communicate with other devices, and specifically, to transmit information or data to other devices or receive information or data transmitted by other devices.

The transceiver 1230 may include a transmitter and a receiver. The transceiver 1230 may further include an antenna, and the number of antennas may be one or more.

In an implementation, the communication device 1200 may be the first communication device in the embodiments of the present disclosure, and the communication device 1200 may implement the corresponding processes implemented by the first communication device in various methods in the embodiments of the present disclosure, which will not be repeated here for the sake of brevity.

In an implementation, the communication device 1200 may be the second communication device in the embodiments of the present disclosure, and the communication device 1200 may implement the corresponding processes implemented by the first communication device in various methods in the embodiments of the present disclosure, which will not be repeated here for the sake of brevity.

FIG. 13 is a schematic structural diagram of a chip 1300 according to the embodiments of the present disclosure. The chip 1300 includes a processor 1310, and the processor 1310 may call a computer program from a memory and run the computer program, to implement the methods in the embodiments of the present disclosure.

In an implementation, the chip 1300 may further include a memory 1320. The processor 1310 may call a computer program from the memory 1320 and run the computer program, to implement the methods performed by the first communication device or the second communication device in the embodiments of the present disclosure.

The memory 1320 may be a separate device independent of the processor 1310, or may be integrated into the processor 1310.

In an implementation, the chip 1300 may further include an input interface 1330. The processor 1310 may control the input interface 1330 to communicate with other devices or chips, and specifically, may obtain information or data transmitted by other devices or chips.

In an implementation, the chip 1300 may further include an output interface 1340. The processor 1310 may control the output interface 1340 to communicate with other devices or chips, and specifically, may output information or data to other devices or chips.

In an implementation, the chip may be applied to the first communication device in the embodiments of the present disclosure, and the chip may implement the corresponding processes implemented by the first communication device in various methods in the embodiments of the present disclosure, which will not be repeated here for the sake of brevity.

In an implementation, the chip may be applied to the second communication device in the embodiments of the present disclosure, and the chip may implement the corresponding processes implemented by the second communication device in various methods in the embodiments of the present disclosure, which will not be repeated here for the sake of brevity.

The chips used in the first communication device and the second communication device may be the same chip or different chips.

It should be understood that the chip mentioned in the embodiments of the present disclosure may also be referred to as a system-level chip, a system chip, a chip system, a system-on-chip, or the like.

The processor mentioned above may be a general-purpose processor, a digital signal processor (DSP), a field programmable gate array (FPGA), an application specific integrated circuit (ASIC) or other programmable logic devices, transistor logic devices, discrete hardware components, or the like. Here, the general purpose processor mentioned above may be a microprocessor or any conventional processor, or the like.

The memory mentioned above may be a volatile memory or a non-volatile memory, or may include both the volatile memory and non-volatile memory. Here, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or a flash memory. The volatile memory may be a random access memory (RAM).

It should be understood that the above memory is exemplary but not a limited illustration. For example, the memory in the embodiments of the present disclosure may also be a static RAM (SRAM), a dynamic RAM (DRAM), a (SDRAM)), a double data rate SDRAM (DDR SDRAM), an enhanced SDRAM (ESDRAM), a synch link DRAM (SLDRAM), a direct Rambus RAM (DR RAM), or the like. That is, the memory in the embodiments of the present disclosure is intended to include, but not limited to, these and any other suitable types of memories.

FIG. 14 is a schematic block diagram of a communication system 1400 according to the embodiments of the present disclosure. The communication system 1400 includes a first communication device 1410 and a second communication device 1420. The first communication device 1410 is configured to determine whether to transmit the first measurement report based on the first condition in response to the first-type frequency point meeting the first reporting condition. The second communication device 1420 is configured to transmit the first measurement configuration, where the first measurement configuration is used for assisting the first communication device in determining whether to transmit a first measurement report based on the first condition in response to the first-type frequency point meeting the first reporting condition. The first communication device 1410 may be configured to implement the corresponding functions implemented by the first communication device in the above method, and the second communication device 1420 may be used for implementing the corresponding functions implemented by the second communication device in the above method, which will not be repeated here for the sake of brevity.

The above embodiments, in whole or in part, may be implemented by software, hardware, firmware or any conjunction thereof. When implemented by using software, they, in whole or in part, may be implemented in the form of a computer program product. The computer program product includes one or more computer instructions. When the computer program instructions are loaded and performed on a computer, the procedures or functions according to the embodiments of the present disclosure are generated in whole or in part. The computer may be a general purpose computer, a special purpose computer, a computer network, or other programmable apparatus. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server, or a data center to another website, computer, server, or data center in a wired (e.g., coaxial cable, optical fiber, digital subscriber line (DSL)) or wireless (e.g., infrared, radio, microwave, or the like.) manner. The non-transitory computer-readable storage medium may be any available medium that can be accessed by a computer, or a data storage device such as a server or a data center that includes one or more available media integrated therein. The available medium may be a magnetic medium (e.g., a floppy disk, a hard disk, a magnetic tape), an optical medium (e.g., a digital video disk (DVD)), or a semiconductor medium (e.g., a solid state disk (SSD)), or the like.

It should be understood that in the various embodiments of the present disclosure, the magnitude of the sequence numbers of the aforementioned processes do not mean the order of execution. The order of execution of the aforementioned various processes should be determined by their functions and internal logics, and shall not constitute any limitation on the implementation process of the embodiments of the present disclosure.

Those skilled in the art may clearly understand that for the convenience and brevity of the description, the specific operating processes of the system, apparatus and unit described above may refer to the corresponding processes in the aforementioned method embodiments, which will not be repeated here.

The foregoing descriptions are merely specific implementations of the present disclosure, but the protection scope of the present disclosure is not limited thereto. Any skilled person in the art could readily conceive of changes or replacements within the technical scope disclosed in the present disclosure, which shall be all included within the protection scope of the present disclosure. Therefore, the protection scope of the present disclosure shall be on the basis of the protection scope of claims.

What is claimed is:

1. A communication method, comprising:
determining, by a first communication device, whether to transmit a first measurement report based on a first condition in response to a first-type frequency point meeting a first reporting condition.

2. The method according to claim 1, wherein determining whether to transmit the first measurement report based on the first condition comprises:
transmitting the first measurement report in response to the first condition being met.

3. The method according to claim 1, wherein the method further comprises:
receiving, by the first communication device, a first measurement configuration; and
performing, by the first communication device, measurement on the first-type frequency point and/or a second-type frequency point based on the first measurement configuration;
wherein the first measurement configuration comprises at least one of following: a threshold related to a measurement result; a first timer duration; a priority threshold; a first frequency point list; first indication information; or a cell list.

4. A first communication device, comprising: a processor and a memory, wherein the memory is configured to store a computer program, and the processor is configured to call the computer program stored in the memory and run the computer program, to enable the first communication device to perform:
determining whether to transmit a first measurement report based on a first condition in response to a first-type frequency point meeting a first reporting condition.

5. The first communication device according to claim 4, wherein the processor is configured to call the computer program stored in the memory and run the computer program, to enable the first communication device further to perform:
transmitting the first measurement report in response to the first condition being met.

6. The first communication device according to claim 4, wherein the processor is configured to call the computer program stored in the memory and run the computer program, to enable the first communication device further to perform:
receiving a first measurement configuration; and
performing measurement on the first-type frequency point and/or a second-type frequency point based on the first measurement configuration;
wherein the first measurement configuration comprises at least one of following: a threshold related to a measurement result; a first timer duration; a priority threshold; a first frequency point list; first indication information; or a cell list.

7. The first communication device according to claim 4, wherein the first condition comprises at least one of following:
a measurement result of a second-type frequency point meeting a first threshold;
a first timer timing out;
a measurement result of a current serving cell meeting a second threshold;
a difference between a measurement result of the first-type frequency point and a measurement result of a second-type frequency point meeting a third threshold;
determining, based on a network indication, that the first-type frequency point is a frequency point at which a measurement result is allowed to be directly reported in response to a reporting condition being met;
a priority of the first-type frequency point being not lower than a priority threshold;
a first cell at the first-type frequency point meeting a reporting condition;
at least N cells that meet a reporting condition at the first-type frequency point existing, N being a positive integer; or
it being predicted that measurement reporting of a second-type frequency point is to be triggered within a first-time window.

8. The first communication device according to claim 7, wherein the processor is configured to call the computer program stored in the memory and run the computer program, to enable the first communication device further to perform:
starting a first timer in response to the measurement result of the first-type frequency point meeting the first reporting condition; and
determining whether to transmit the first measurement report based on a state of the first timer;
wherein determining whether to transmit the first measurement report based on the state of the first timer comprises at least one of following:
transmitting the first measurement report in response to the first timer timing out;
transmitting the first measurement report in response to the first timer timing out and the measurement result of the first-type frequency point meeting the first reporting condition;
during running of the first timer, stopping the first timer and transmitting the first measurement report, in response to the measurement result of the second-type frequency point meeting a second reporting condition; or
during running of the first timer, stopping the first timer and transmitting the first measurement report, in response to the measurement result of the serving cell meeting the second threshold.

9. The first communication device according to claim 7, wherein the processor is configured to call the computer program stored in the memory and run the computer program, to enable the first communication device further to perform:
in a case where the measurement result of the first-type frequency point meets the first reporting condition, determining whether to transmit the first measurement report based on at least one of the network indication, the priority of the first-type frequency point, or a measurement result of a cell at the first-type frequency point;
wherein first-type frequency point configuration comprises first indication information, or first indication information in first-type frequency point configuration is a true value; and
the first indication information is used for indicating whether the first communication device is allowed to directly report the first measurement report in response to the first-type frequency point meeting the first reporting condition;
wherein the first-type frequency point configuration is comprised in a first frequency point list, the first frequency point list is comprised in a first measurement configuration, and the first frequency point list comprises one or more frequency points at which the first communication device directly transmits the first measurement report in response to the reporting condition being met.

10. The first communication device according to claim 9, wherein the priority of the first-type frequency point is not lower than the priority threshold, and the first communication device transmits the first measurement report in response to the first reporting condition being met; and
in a case where the first-type frequency point comprises multiple measurement frequency points, a frequency point with a highest priority among the multiple measurement frequency points is used for comparison with the priority threshold.

11. The first communication device according to claim 4, wherein the first measurement report comprises at least one of following: a measurement result of the first-type frequency point; a measurement state of the first-type frequency point; a measurement result of a second-type frequency point; or a measurement state of the second-type frequency point; and
the measurement state of the second-type frequency point comprises at least one of following:
whether measurement being performed on the second-type frequency point; or
whether the measurement result of the second-type frequency point meeting an entering state.

12. The first communication device according to claim 11, wherein a second condition of the first measurement report comprising the measurement result of the second-type frequency point and/or the measurement state of the second-type frequency point comprises at least one of following:
the measurement result of the second-type frequency point meeting a fourth threshold;
a difference between the measurement result of the first-type frequency point and the measurement result of the second-type frequency point meeting a fifth threshold; or
determining, based on a network indication, that the first communication device needs to report the measurement result of the second-type frequency point while reporting the measurement result of the first-type frequency point.

13. The first communication device according to claim 11, wherein a manner for determining a priority relationship between the first-type frequency point and the second-type frequency point comprises at least one of following:
a manner based on priority configuration associated with the first-type frequency point and the second-type frequency point, the priority configuration comprising an index value for representing a priority associated with each measurement frequency point in the first-type frequency point and the second-type frequency point; or
a manner based on an order of the first-type frequency point and the second-type frequency point in a measurement frequency point list.

14. A second communication device, comprising: a processor and a memory, wherein the memory is configured to store a computer program, and the processor is configured to call the computer program stored in the memory and run the computer program, to enable the second communication device to perform:
transmitting a first measurement configuration, wherein the first measurement configuration is used for assisting a first communication device in determining whether to transmit a first measurement report based on a first condition in response to a first-type frequency point meeting a first reporting condition.

15. The second communication device according to claim 14, wherein the first measurement configuration comprises at least one of following: a threshold related to a measurement result; a first timer duration; a priority threshold; a first frequency point list; first indication information; or a cell list.

16. The second communication device according to claim 15, wherein the first frequency point list comprises one or more frequency points at which the first communication device directly transmits the first measurement report in response to the reporting condition being met; or
wherein the first frequency point list comprises first-type frequency point configuration, the first-type frequency point configuration comprises first indication information, or first indication information in the first-type frequency point configuration is a true value; and
the first indication information is used for indicating whether the first communication device is allowed to directly report the first measurement report in response to the first-type frequency point meeting the first reporting condition.

17. The second communication device according to claim 14, wherein the processor is configured to call the computer program stored in the memory and run the computer program, to enable the second communication device further to perform:
receiving the first measurement report transmitted by the first communication device in response to the first-type frequency point meeting the first reporting condition and the first condition being met;
wherein the first condition comprises at least one of following:
a measurement result of a second-type frequency point meeting a first threshold;
a first timer timing out;
a measurement result of a current serving cell meeting a second threshold;
a difference between a measurement result of the first-type frequency point and a measurement result of a second-type frequency point meeting a third threshold;
determining, based on a network indication, that the first-type frequency point is a frequency point at which a measurement result is allowed to be directly reported in response to a reporting condition being met;
a priority of the first-type frequency point being not lower than a priority threshold;
a first cell at the first-type frequency point meeting a reporting condition;
at least N cells at the first-type frequency point that meet a reporting condition existing, N being a positive integer; or
it being predicted that measurement reporting of a second-type frequency point will be triggered within a first-time window.

18. The second communication device according to claim 17, wherein the first measurement report comprises at least one of following: the measurement result of the first-type frequency point; a measurement state of the first-type frequency point; the measurement result of the second-type frequency point; or a measurement state of the second-type frequency point; and/or
the measurement state of the second-type frequency point comprises at least one of following:
whether measurement being performed on the second-type frequency point; or
whether the measurement result of the second-type frequency point meeting an entering state.

19. The second communication device according to claim 17, wherein a second condition of the first measurement report comprising the measurement result of the second-type frequency point and/or a measurement state of the second-type frequency point comprises at least one of following:
the measurement result of the second-type frequency point meeting a fourth threshold;
a difference between the measurement result of the first-type frequency point and the measurement result of the second-type frequency point meeting a fifth threshold; or
determining, based on the network indication, that the first communication device needs to report the measurement result of the second-type frequency point while reporting the measurement result of the first-type frequency point.

20. The second communication device according to claim 17, wherein a manner for determining a priority relationship between the first-type frequency point and the second-type frequency point comprises at least one of following:
a manner based on priority configuration associated with the first-type frequency point and the second-type frequency point, the priority configuration comprising an index value for representing a priority associated with each measurement frequency point in the first-type frequency point and the second-type frequency point; or
a manner based on an order of the first-type frequency point and the second-type frequency point in a measurement frequency point list.
